(19) United States
(12) Patent Application Publication
(10) Pub. No.: US 2019/0087425 A1
(43) Pub. Date: Mar. 21, 2019

(54) APPARATUS AND METHOD FOR RECOGNIZING OLFACTORY INFORMATION RELATED TO MULTIMEDIA CONTENT AND APPARATUS AND METHOD FOR GENERATING LABEL INFORMATION

(71) Applicant: Electronics and Telecommunications Research Institute, Daejeon (KR)

(72) Inventors: Sang Yun KIM, Daejeon (KR); Sung June CHANG, Daejeon (KR); Hae Ryong LEE, Daejeon (KR); Jun Seok PARK, Daejeon (KR); Joon Hak BANG, Sejong-si (KR); Jong Woo CHOI, Daejeon (KR)

(73) Assignee: Electronics and Telecommunications Research Institute, Daejeon (KR)

(21) Appl. No.: 15/822,393

(22) Filed: Nov. 27, 2017

(30) Foreign Application Priority Data
Sep. 18, 2017 (KR) 10-2017-0119835

(51) Int. Cl. G06F 17/30; G06N 3/04; G06N 99/00

(52) U.S. Cl. CPC G06F 17/30038; G06N 99/005; G06N 3/04

(57) ABSTRACT

An apparatus for recognizing olfactory information related to multimedia content may comprise a processor. The processor may receive the multimedia content, detect one or more first objects and first label information with respect to the one or more first objects included in the multimedia content, extract second label information including relative position information of the one or more first objects in the multimedia content, and generate third label information by using a result of identifying whether the detected one or more first objects are odor objects related to odors.

### CLAIM FOR PRIORITY

This application claims priority to Korean Patent Application No. 2017-0119835 filed on Sep. 18, 2017 in the Korean Intellectual Property Office (KIPO), the entire contents of which are hereby incorporated by reference.

### BACKGROUND

### 1. Technical Field

Example embodiments of the present invention relate in general to a method of representing content related to an odor in a system which provides multimedia content on the basis of Internet of Things (IoT), and more particularly, to a technology of representing odor content related to standards of Internet of Media Things and Wearables (IoMT).

### 2. Related Art

Due to developments in wireless communication technology, Internet of Things (IoT) technology becomes influential. Now, times in which things have intellectualized components and collect, share, and transmit and receive information have arrived.

As standards for adding a multimedia function to the IoT and providing more abundant user experience through interaction between a fixed thing and a wearable thing, a discussion on Internet of Media Things and Wearables (IoMT) standards has been performed.

Multimedia and multimedia content sharable by the IoMT technology may provide a variety of user experiences. One of them is sharing of user experiences based on olfactory sense.

Not limited to IoT, as technologies of sharing user experiences based on olfactory sense as related art, there are present technologies of providing user experiences based on olfactory sense to a user by emitting a predetermined scent while being synchronized with predetermined time information during a movie.

However, in the related art, there is a limitation in categories of sharable olfactory experience and it is impossible to provide means for allowing persons to easily share olfactory experience.

Also, not limited to olfactory information, there have been attempts for extracting direct or indirect user experience from multimedia content. However, in the related arts, for example, a process of extracting user experience from image content through supervised learning/unsupervised learning and the like in the case of image analysis consumes a large amount of resource.

### SUMMARY

Accordingly, example embodiments of the present invention are provided to substantially obviate one or more problems due to limitations and disadvantages of the related art.

Example embodiments of the present invention provide an apparatus for recognizing olfactory information related to multimedia content.

Example embodiments of the present invention also provide a method for recognizing olfactory information related to multimedia content.

Example embodiments of the present invention also provide an apparatus for generating label information.

Example embodiments of the present invention also provide a method for generating label information.

In order to achieve the objective of the present disclosure, an olfactory information recognizer, which recognizes olfactory information based on multimedia content, may comprise a processor, and the processor may receive the multimedia content, detect one or more first objects and first label information with respect to the one or more first objects included in the multimedia content, extract second label information including relative position information of the one or more first objects in the multimedia content, and generate third label information by using a result of identifying whether the detected one or more first objects are odor objects related to odors.

The processor may generate fourth label information by using a result of determining whether a second object, which is one of the one or more first objects and identified to be the odor object with respect to the multimedia content, is a dominant odor object of the multimedia content.

The processor may determine a ratio between an area occupied by the second object identified to be the odor object with respect to the multimedia content among the one or more first objects to the multimedia content, and whether the second object is the dominant odor object of the multimedia content on the basis of a relative position in the multimedia content.

The processor may perform machine learning with respect to the multimedia content by applying the first label information with respect to one or more first objects to a weakly supervised learning process and extract the second label information with respect to the one or more first objects on the basis of a parameter obtained as a result of the machine learning by applying the first label information to the weakly supervised learning process.

The processor may extract the second label information with respect to the one or more first objects on the basis of a distribution of feature weights of a convolution filter of a convolution neural network (CNN) while the machine learning by applying the first label information to the weakly supervised learning process is performed.

The processor may perform machine learning with respect to the multimedia content by applying the first label information with respect to the one or more first objects to a weakly supervised learning process and form a model which is an assembly of data including the first label information, the second label information, and the third label information with respect to the multimedia content as a result of the machine learning.

In order to achieve the objective of the present disclosure, a label information generator, which generates label information based on multimedia content, may comprise a processor, and the processor may receive the multimedia content, detect one or more first objects and first label information with respect to the one or more first objects included in the multimedia content, perform machine learning with respect to the multimedia content by applying the first label information with respect to the one or more first objects to a weakly supervised learning process, and extract the second label information with respect to the one or more first objects on the basis of a parameter obtained as a result of the machine learning by applying the first label information to the weakly supervised learning process.

The processor may extract the second label information with respect to the one or more first objects on the basis of a distribution of feature weights of a convolution filter of a convolution neural network (CNN) while the machine learning by applying the first label information to the weakly supervised learning process is performed.

The processor may form a model which is an assembly of data including the first label information and the second label information with respect to the multimedia content as a result of the machine learning.

The processor may analyze unlabeled second multimedia content by using the model and detect first label information and second label information with respect to a second object included in the second multimedia content as a result of analyzing the second multimedia content.

In order to achieve the objective of the present disclosure, an olfactory information recognition method, which is recognizing olfactory information based on multimedia content and executed by a device which forms Internet of Things (IoT) and includes a processor, may comprise receiving, by the processor, the multimedia content, detecting, by the processor, one or more first objects and first label information with respect to the one or more first objects included in the multimedia content, extracting, by the processor, second label information including relative position information of the one or more first objects in the multimedia content, and generating third label information by using a result of identifying whether the detected one or more first objects are odor objects related to odors.

The olfactory information recognition method may further comprise generating, by the processor, fourth label information by using a result of determining whether a second object, which is one of the one or more first objects and identified to be the odor object with respect to the multimedia content, is a dominant odor object of the multimedia content.

The generating of the fourth label information by using the result of determining whether the second object is the dominant odor object of the multimedia content may comprise generating the fourth label information by using the result of determining whether the second object is the dominant odor object of the multimedia content on the basis of a ratio of an area occupied by the second object in the multimedia content and a relative position thereof in the multimedia content.

The olfactory information recognition method may further comprise, by the processor, forming a model which is an assembly of data including the first label information, the second label information, and the third label information with respect to the multimedia content as a result of performing machine learning with respect to the multimedia content by applying the first label information with respect to the one or more first objects to a weakly supervised learning process.

In order to achieve the objective of the present disclosure, a label information generation method, which is generating label information based on multimedia content and executed by a device which forms Internet of Things (IoT) and includes a processor, may comprise receiving, by the processor, the multimedia content, detecting, by the processor, one or more first objects and first label information with respect to the one or more first objects included in the multimedia content, performing, by the processor, machine learning with respect to the multimedia content by applying the first label information with respect to the one or more first objects to a weakly supervised learning process, and extracting, by the processor, the second label information with respect to the one or more first objects on the basis of a parameter obtained as a result of the machine learning by applying the first label information to the weakly supervised learning process.

The extracting of the second label information may comprise extracting the second label information with respect to the one or more first objects on the basis of a distribution of feature weights of a convolution filter of a convolution neural network (CNN), obtained while the machine learning by applying the first label information to the weakly supervised learning process is performed.

The label information generation method may further comprise forming, by the processor, a model which is an assembly of data including the first label information and the second label information with respect to the multimedia content as a result of the machine learning.

The label information generation method may comprise analyzing, by the processor, unlabeled second multimedia content by using the model and detecting, by the processor, first label information and second label information with respect to a second object included in the second multimedia content as a result of analyzing the second multimedia content.

According to the embodiments of the present invention, not only content directly provided by multimedia shared by the IoMT technology but also user experience indirectly induced by the content may be extracted and shared. According to the embodiments of the present invention, information on an object related to olfactory sense may be extracted on the basis of content.

According to the embodiments of the present invention an object related to user experience may be identified in large-scale content data and more upgraded information related to the identified object may be obtained. According to the embodiments of the present invention, a dataset for supervised learning or partial supervised learning may be generated as an effective tool for machine learning by using a small resource.

According to the embodiments of the present invention, a dataset adequate for extracting an odor object from multimedia content may be generated. Also, a model which is an assembly of information on an object in content may be formed by machine learning.

According to the embodiments of the present invention, a dataset which is a base for lowering a barrier necessary for extracting an odor object from multimedia content and allowing users to easily extract odor objects and olfactory information from the content may be provided.

According to the embodiments of the present invention, users may share multimedia content and on-site synesthesia together by reducing time and cost for extracting odor objects and olfactory information in multimedia content.

An odor object provided by the present invention may be an odor image which is an object in image data and associated with a particular odor or may be an odor sound which is an object in sound data and associated with a particular odor.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating a concept of Semi-Supervised Learning (SSL) which is a related art;

FIG. 2 is a view illustrating a process of generating label information based on multimedia content according to one embodiment of the present invention;

FIG. 3 is a view illustrating a process of recognizing olfactory information based on multimedia content according to one embodiment of the present invention;

FIGS. 4 to 6 are views illustrating a process of generating label information based on multimedia content according to one embodiment of the present invention;

FIG. 7 is a view illustrating a process of recognizing olfactory information based on multimedia content in an Internet of Things (IoT) environment according to one embodiment of the present invention;

FIG. 8 is a flowchart illustrating an olfactory information recognition method according to one embodiment of the present invention;

FIG. 9 is a flowchart illustrating an olfactory information recognition method according to one embodiment of the present invention;

FIG. 10 is a flowchart illustrating a label information generation method according to one embodiment of the present invention; and

FIG. 11 is a flowchart illustrating a label information generation method according to one embodiment of the present invention.

### DESCRIPTION OF EXAMPLE EMBODIMENTS

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings.

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein.

A device included as a part of a configuration of the present invention may form Internet of Things (IoT). When the device which forms IoT has a multimedia function, it may be referred to as a Media thing (Mthing). It is a main issue of the present invention to transmit and receive a variety of user experiences through a network of Mthings.

The device provided by the present invention may include a camera, a recorder, a video camera, and the like, which can collect an image, a sound, and the like and may share olfactory information while interworking with an electronic nose (E-nose) capable of collecting olfactory information. Also, the device provided by the present invention may interwork with a scent emitting device. The scent emitting device may retain scent components and may actually embody olfactory information by a combination of some or all of the scent components.

As one type of the scent emitting device stated herein, there may be present a scent display or an olfactory display. The terms “the scent display” or “the olfactory display” adds a scent to multimedia content and provides the user with the scent-added content while interworking with, for example, a personal computer, a laptop computer, a mobile terminal, a television, or an audiovisual display such as a head mounted display (HMD) and the like. The scent display or the olfactory display may include a scent cartridge which includes the scent components and may further include a controller or a processor which controls the scent cartridge to embody a scent atmosphere by discharging the scent component or a combination of scent components.

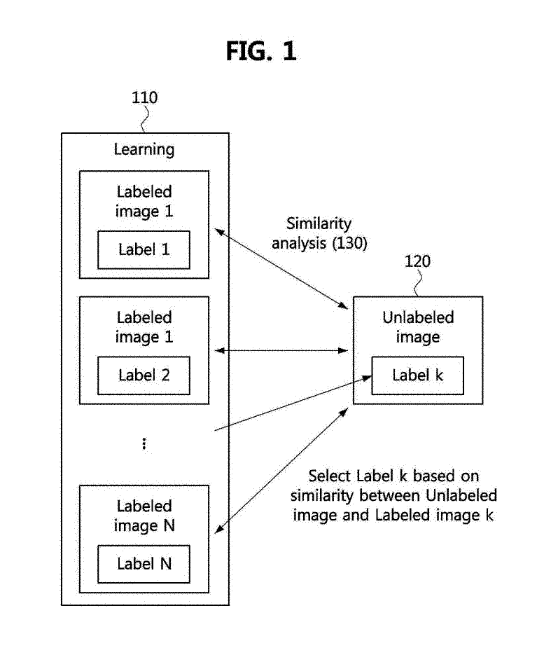

FIG. 1 is a view illustrating a concept of Semi-Supervised Learning (SSL) which is a related art. The shown in FIG. 1 may be utilized as a part of the configuration of the present invention.

Referring to FIG. 1, machine learning is performed by using a combination of an arbitrary N number of labeled images. A label of each image is information which states features of the image. As a result of learning, a dataset is generated as a result of synthetic analysis related to a correlation between each image and each label. A process up to here is performed by supervised learning.

Afterward, similarity analysis between an unlabeled image and a labeled image is performed to generate a label of the unlabeled image. Here, a labeled image K which has the highest similarity with the unlabeled image or a similarity of a certain reference or more may be selected according to the certain reference. Since the unlabeled image is similar to the labeled image k, a label k of the labeled image k may be selected as label information of the unlabeled image.

As described above, the SSL which is related art performs analysis/learning with respect to an unlabeled image by learning labeled images. The SSL may add label information of an unlabeled image by applying a learning result with respect to a labeled image and an unlabeled image. The above process may be referred to labeling propagation.

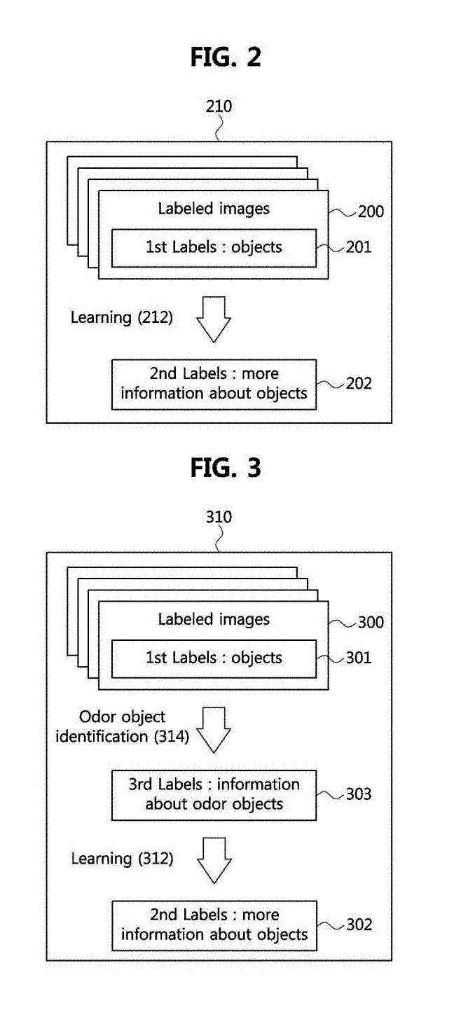

FIG. 2 is a view illustrating a process of generating label information based on multimedia content according to one embodiment of the present invention. The process of FIG. 2 may be executed by a processor of a computing system. The process of FIG. 2 may be executed by a processor of a server, may be executed by an application processor of a mobile terminal, and may be executed by a processor of a device receiving a support of cloud computing.

Referring to FIG. 2, in addition to first labels 201 retained by labeled images 200, additional information in the labeled images 200 may be generated as second labels 202 through machine learning 212 with respect to labeled images 200. Here, the first labels 201 refer to basic information with respect of types or titles of objects included in the labeled images 200.

For example, when a particular photo includes a vehicle, a label “vehicle” may be given to the photo. Meanwhile, statements such as “sedan,” “truck,” and “SUV” which refer to types of vehicle may be added as labels. Here, the first labels 201 only refer to information on which object is included in an image and do not include a relative position of the object in the image, a size of the object, and the like.

Also, a particular image may not show only one object. For example, both a vehicle and a human being may be shown in an image and both the vehicle and the human being may be stated in a label with respect to the image. In this case, it is assumed that there is no information on which object is a vehicle and which object is a human being in the image.

In the specification, an object indicated by each of the first labels 201 retained in a particular image will be referred to as first objects for convenience.

When going through weakly supervised learning (212) of the present invention, additional information with respect to the first objects may be generated as second labels 202 in addition to the first labels 201 with respect to the first objects and retained in the labeled images 200. Here, information included in the second labels 202 may include sizes of areas occupied by the first objects in the image, a ratio of the sizes, relative positions of the first objects in the image, and the like may be included.

As a result of the weakly supervised learning of the present invention, a model 210 may be generated as a dataset which is abstract and includes the first labels 201 and the second labels 202 with respect to the first objects, which are included in the labeled images 200.

The model 210 is a data assembly which includes weights and links among pieces of information, derived during a learning process. For example, when a convolution neural network (CNN) is used during the learning process, the generated weights may be represented as a matrix assembly depending on a CNN structure. The weights may be modified into appropriate values to estimate a desirable result by comparing an inference result derived through weights during the learning with correct answers (the first labels 201).

Since levels of the weights are proportional to the CNN structure and the weights are modified during the learning, the weights used for inferring labels are present as significant information in the model 210 after the learning stops. The model 210 may be stored and maintained in a database after the learning is completed, may be called when inference with respect to an unlabeled image is necessary, and may be used as a medium of the inference with respect to the unlabeled image.

FIG. 3 is a view illustrating a process of recognizing olfactory information based on multimedia content according to one embodiment of the present invention.

Referring FIG. 3, labeled images 300 include at least one first object and include first labels 301 with respect to the first objects, which is identical to the shown in FIG. 2 and a repetitive description will be omitted.

It may be determined whether the first objects included in the labeled images 300 are odor objects related to olfactory sense (314). For example, when an object included in an image is a “vehicle,” since a smell of gasoline, a smell of exhaust fumes, and the like are associated, “vehicle” may be classified as an odor object. Meanwhile, since “flower” is associated with a scent of a flower, “flow” may be classified as an odor object. Also, since food like “cake” is associated with a particular smell, “cake” may also be classified as an odor object. Since “desert,” “wood,” “lake,” “sea,” and the like, which are background, are associated with particular atmospheres and smells, they may be classified as odor objects. However, even when classified as odor objects, objects with a high degree of being associated with smells may be distinguished from objects with a low degree thereof.

Meanwhile, since “human” is difficult to recognize a particular smell through only a label thereof, it is difficult to be an odor object. A process of classifying a particular object as an odor object may be executed through comparison and analysis with a reference database which defines a correlation between objects and smells.

Through an odor object identification process 314, information on whether each of the first objects referred to as the first labels 301 is an odor object may be generated as third labels 303. A next learning process 312 may be performed on only objects identified to be odor objects by referring the third labels 303.

A weakly supervised learning process 312 is identical to that described with reference to FIG. 2. Through the weakly supervised learning process 312, the labeled images 300 may be related to the first labels 301, the second labels 302 which include relative position information and additional information on size, and the third labels 303 which include information on whether an object is an odor object. A dataset which is abstract and includes the labeled images 300, the first labels 301, the second labels, the third labels 303, and information on correlations among the labeled images 300, the first labels 301, the second labels 302, and the third labels 303 is generated as the model 310.

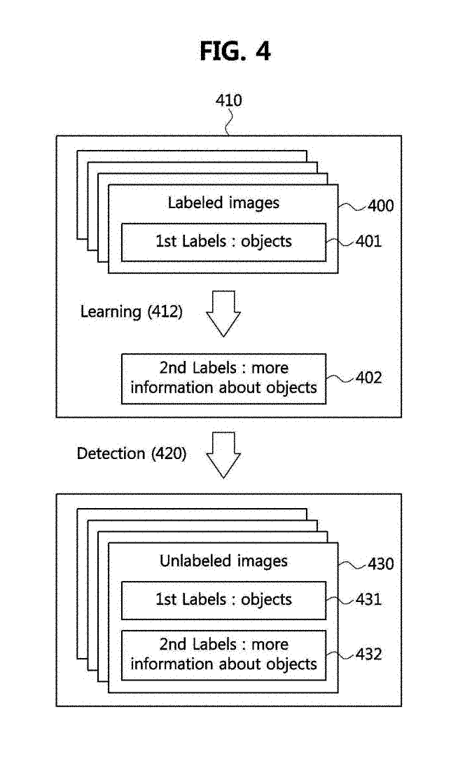

FIG. 4 is a view illustrating a process of generating label information based on multimedia content according to one embodiment of the present invention.

Referring to FIG. 4, second labels 402 with respect to first objects included in labeled images 400 are generated through weakly supervised learning 412 by using the labeled images 400 and first labels 401 related to the labeled images 400. Like the above description with reference to FIGS. 2 and 3, the model 410 is formed as an assembly of label information generated through the weakly supervised learning 412.

Referring to FIG. 4, a detection 420 process using the model 410 is executed on unlabeled images 430. Since the model 410 includes information on not only types but also positions and sizes of objects in an image, as a result of the detection using the model 410, with respect to second objects included in the unlabeled images 430, second labels 432 which include sizes of areas occupied by the second objects and relative position information thereof in the unlabeled images 430 are derived in addition to first labels 431 with respect to types of the second objects.

Although a process of deriving information on objects included in unlabeled images by applying a result of learning with respect to labeled images to unlabeled images is already known art as shown before in FIG. 1, it is difficult to specify an object to be compared in an image by using only the information on types of objects included in a labeled image in the related art. That is, when a flower and an animal (for example, a dog) are included together in an image, although a human being easily distinguishes the flower from the dog in the image in light of experience till now, artificial intelligence can not determine which one among objects in the image is the flower and which one is the animal from the beginning.

Due to this, there is a limitation of manually adding an additional labeling operation with respect to a labeled image in the related art. That is, additional labels which refer to which one is the flower and which one is the dog are manually made with respect to the labeled image and the may be utilized as reference of supervised learning. That is, since a “correct answer” for a position of the object in the image is necessary here, a process of additionally making the “correct answer” in the image or adding additional information is necessary.

Generally obtained labeled images do not include position information with respect to objects in an image and generally include only information on types of the objects. This is because a label with respect to an image is not generated on the premise machine learning and generally made while it is assumed that a human except a label maker utilizes the label. Accordingly, a process of reprocessing a generally obtained labeled image was surely necessary to apply supervised learning/semi-supervised learning of related art. A reprocessing operation necessary in the related art may refer, for example, an additional label such as a box label with respect to an object in the image. In the related art, an operation of reprocessing an object included in a label to distinguish the object from other areas by making an additional box label with respect thereto is necessary to accurately recognize the object in the image.

As described above, when an additional box-making operation with respect to the object in the image is manually performed one by one, a load of operation increases as data increases. Due to this, the reprocessing operation for the related art acts as a limitation in increasing the number of data for supervised learning.

Meanwhile, depending on utilization of machine learning, a target outcome to be finally obtained may differ. For example, when it is necessary to precisely recognize a position of an object in an image, it is necessary to precisely show the object in the image and the position of the object in label information. However, like the present invention, when it is necessary to compare only an approximate position of an object in an image with a relative position thereof and compare relative sizes of objects, it is unnecessary for label information to have “correct answer” for a position of the object.

Accordingly, in the present invention, it is assumed that it is unnecessary to precisely recognize an absolute size and an absolute position of an object in an image and it is necessary to recognize a dominant object among objects in an image and to compare relative positions and relative sizes of objects. Also, the present invention provides a supervised learning process which does not need “correct answer” of the position of the object.

The present invention may generate a learning model with adequately high precision by using a labeled image being generally obtainable, that is, data including only simple information on types of objects in an image. Accordingly, there is an advantage of performing the supervised learning by using a large number of sample data without additional processing on the labeled image.

In the present invention, information on relative positions and relative sizes of objects in an image may be inferred with respect to unlabeled images by using a mode derived during the learning process related to the labeled image. Through above-described process, a population for learning may be gradually increased by adding a label related to an unlabeled image.

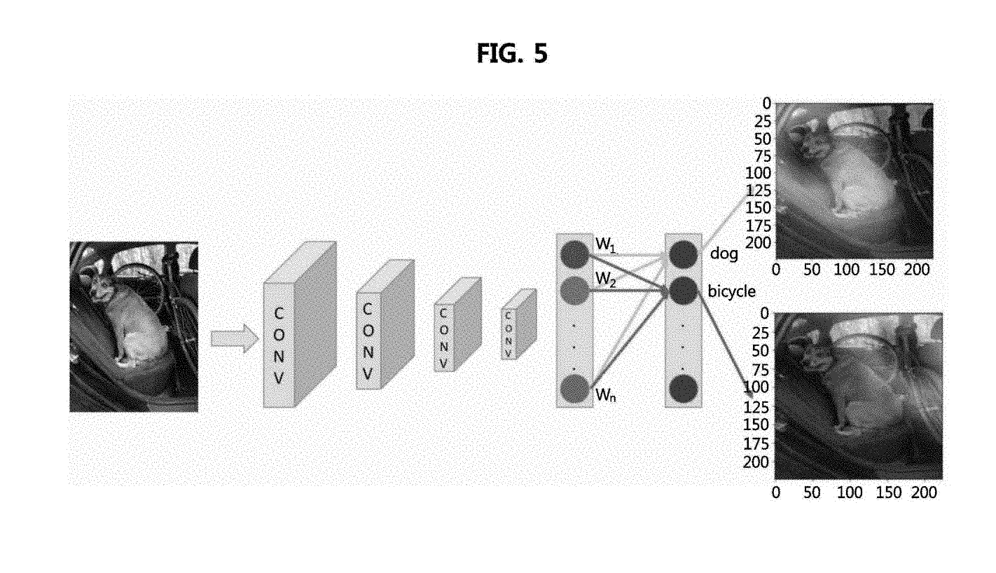

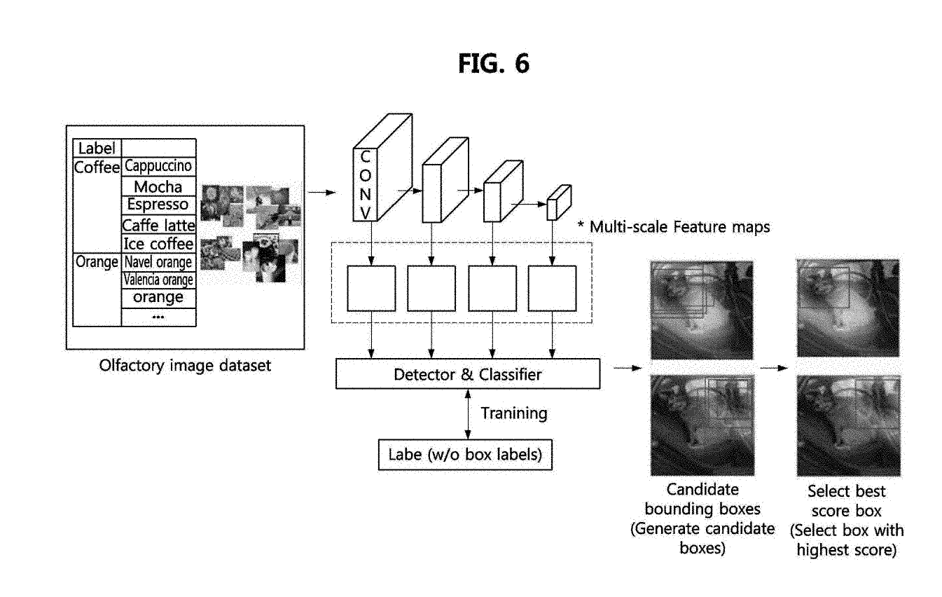

FIGS. 5 to 6 are views illustrating a process of generating label information based on multimedia content according to one embodiment of the present invention.

Referring to FIG. 5, the concept of the weakly supervised learning technique provided by the present invention will be described. Additional information may be obtained by learning using a deep convolution neural network with only a label related to a type of an object without a box label related to a coordinate position of the object.

A part with a high feature weight of a convolution filter is mapped with an image by using a feature of the learned CNN such that which position in the image the CNN concentrates is checked and the concentrated part may be estimated to be a position of the object.

In FIG. 5, positions of a dog and a bicycle in the image are highlighted by red color for each filter by using feature weights derived through the convolution filter. That is, each filter is applied to each of a plurality of objects such that a position of each object may be identified. Through the identification of position, a very precise result is not obtained but it may be determined which one is the dog and which one is the bicycle in the image.

Depending on an application of recognizing a position in an image, whether a very precise position is detected and represented by a box becomes a reference of evaluation related to completeness of a learning process. However, since it is a main aspect of the present invention to utilize an object instead of completing at recognition of a position of the object in an image, it is unnecessary to represent a precise position with a box. Since one of application assumed by the present invention is identification of an odor object in an image and a dominant odor object, a result to be finally obtained is information in which the odor object present in the image is recognized and emits which scent. Bear the application in mind, a manual operation for precisely representing a position of an object in an image with a box is unnecessary and a process of inferring a relative position and a relative size of the object in the image by using a quicker and simpler method is more effective.

A first objective of the present invention is a process of classifying what types of objects are in an image (multi-odor-object classification), and a second objective thereof is a process of approximately recognizing an odor object is present at which position (multi-odor-object localization). It is a third objective to determine which scent is a dominant scent emitted by a scent emitting device by determining the priority in consideration of a size of an odor object, a distance from a center of the image, a distance between odor objects, and the like through the above recognition.

To achieve the objectives of the present invention, a method of making and learning a label including a box of an object for all data may be an optimal method in the related art. However, since an odor is not released by only one object, a variety of objects are necessary to make one odor label and a box label is necessary for each object. Accordingly, considerable time and costs are necessary for manufacturing data. Accordingly, to overcome this, as provided by the present invention, the weakly supervised learning which does not need a box label of an object has considerable advantages.

In the case of odor, there are many cases in which a variety of learning data are necessary for one classification result. For example, in the case of a smell of coffee, since there are present a variety of situations such as coffee beans, coffee in a mug, coffee in a paper cup/plastic cup, canned coffee, and the like, building a dataset capable of deriving odors classified into one category from the variety of situation is not easily achieved by even a manual operation of a human.

Referring to FIG. 6, a process of deriving multi-scale feature maps by applying the CNN to an olfactory image dataset and selecting a box with the highest score after a candidate box is generated for an image will be described.

The concept of weakly supervised learning is not provided by the present invention for the first time. The weakly supervised learning provided by the present invention has differences from conventional weakly supervised learning as follows.

When an objected is detected through general weakly supervised learning for recognizing an object in an image, a class activation mapping method is used. As a feature applied in this case, there is a case of using only the last layer of the CNN.

When only the last layer is used, a limitation of incapable of corresponding to a variety of scales (scales of objects). For overcoming this, although there has been an attempt of overcoming through image-resizing, segmentation, or the like, there was a disadvantage of taking a large amount of time for processing.

When a large amount of time is consumed for processing, it is inadequate for characteristics of olfactory image recognition in which an image is recognized and a scent is emitted in real time, which may hinder variously applications of recognizing and applying an olfactory scent emitting part from a henceforward image on the basis of image recognition.

To overcome this limitation, in the present invention, a single shot multibox detector known as high speed and high precision is applied to the weakly supervised learning technique. That is, when class activation mapping is generated without additional image preprocessing, a multi-scale feature map is generated by using not only the last layer but also features of all CNN layers such that a limitation in scale is overcome by using a different method from weakly supervised object detection of the related art.

Referring to FIG. 6, each convolution layer has a filter with a different scale. In recognition a small object in an input image, filters of all convolution layers are used as feature to prevent an object from being not recognized due to a scale. The multi-scale feature map may be generated by using the filters of the all convolution layers are used as feature. Even objects with different sizes in the image may be recognized to determine whether the objects are utilized as odor objects.

To describe a difficulty in identifying an odor object in an image when the related art is applied, a following example may be provided. For example, in the case of an outdoor barbeque party which a plurality of human beings attend, one or more human beings may be located in a central part in an image. A barbeque image may be located on the periphery in the image. In this case, although the human being is located in the central part which is a dominant position as an object in the image, as described above, the human being is inadequate for an odor object and a barbeque image of objects in the image may be adequate for a dominant odor in an overall situation. In this case, in the related art, only the human beings in the central part may be recognized as objects. However, a result of applying the related art is inadequate for utilizing as odor objects.

Since artificial intelligence does not have advance information of the situation, it is difficult to determine which object among the objects in the image is to be a dominant odor object. Accordingly, in the present invention, there is provided the weakly supervised learning technique improved to identify even a small object among objects in an image and classifying objects recognized as odor objects to recognize a dominant odor object among the odor objects.

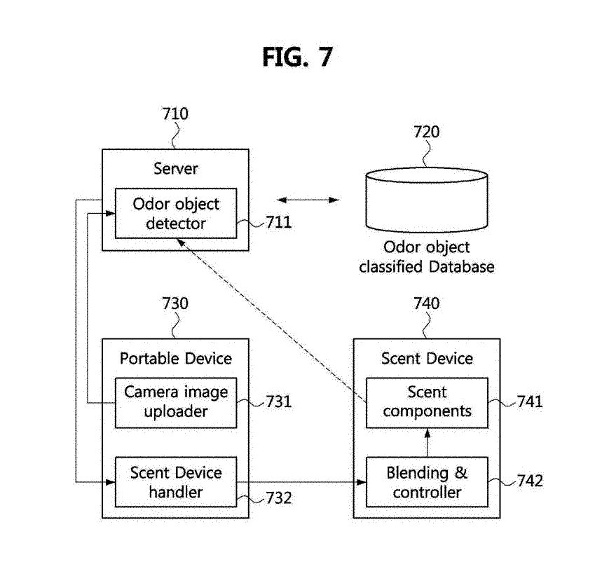

FIG. 7 is a view illustrating a process of recognizing olfactory information based on multimedia content in the IoT environment according to one embodiment of the present invention.

A server 710 may include an odor object detector 711. Here, the odor object detector 711 may be a hardware module embodied to be a separate processor in the server 710 or may be a module executed by the server 710 as a software module embodied by software. Information on objects classified as odor objects may be stored in a database 720 and may be updated.

The odor object detector 711 in the server 710 may recognize an odor object in an image.

A portable device 730 may include a camera image uploader 731 and a scent device handler 732. A scent device 740 may include a scent component 741 and a blending and controller 742.

The camera image uploader 731 may capture and transmit a still image or a video of a camera to the server 710. The scent device handler 732 may control the scent device 740 to emit a scent corresponding to an odor image recognition result received from the server 710. The odor object detector 711 of the server 710 may recognize an odor object by analyzing the still image or video uploaded by the camera image uploader 731.

Here, the odor object detector 711 analyzes whether an object in an image is an object related to olfactory sense while interworking with the database 720. It may be determined according to a classification reference of the database 720 whether the object is an odor object. In detail, whether the object is the odor object may be determined according to whether a particular object is designated as an object related to olfactory sense in the database 720. Meanwhile, even when the object is designated to be the odor object in the database 720, since it is impossible to support a type of scent which is not supported by the scent component 741 retained by the scent device 740 in a system environment of FIG. 7, the odor object detector 711 may receive information a list of scent components 741 from the scent device 740 and may use the information for a reference for identifying an odor object depending on an embodiment.

An olfactory information recognizer according to one embodiment of the present invention may be embodied as any one of the portable device 730 or the server 710 in FIG. 7. The olfactory information recognizer may be described in a data format standardized to share information on an odor object in media things having a multimedia function and capable of accessing the IoT, such as the portable device 730.

The odor object has been described with an odor image for image data as the center for convenience of description but may be embodied as a different type odor object related to the five senses of human. For example, when multimedia content includes a sound as a significant component, a sound associated with a particular smell may be extracted as an odor sound. For example, a meat-roasting sound may be classified as an odor sound associated with a smell of meat, and a fruit-cutting or cooking sound may be classified as an odor sound associated with a smell of fruit. Also, since a sound made while a vehicle runs may be associated with a smell of gasoline, the vehicle may be classified as an odor sound.

When an object capable of being embodied by a particular tactile sensation is associated with a particular smell, an odor object may be defined by tactile sensation.

In the case of tactile sensation or auditory sense, since information provided by content may be smaller than visual information, additional classification may be necessary in consideration of a more abstract situation. For example, as images associated with “smell of coffee,” there may be present coffee beans, water boiled in a coffeepot, coffee in a cup, an image of dripping coffee at a coffee machine, and the like. However, for example, it is not clear to classify a sound of water being boiled to be associated with coffee or other beverages. Here, a process of embodying what an object indicated in corresponding multimedia content is by analyzing further including other pieces of context information associated with content.

Also, information on an odor object may not be represented in single label information and may be hierarchical information including a superordinate concept and a subordinate concept which are abstract. For example, coffee beans may be classified as a smell of coffee which is a superordinate concept but may be classified as favorite beverages which is a more superordinate concept. Circumstantially, when any one of coffee and tea is not awkward in context, corresponding content may be recognized as a scent object corresponding to a scent of tea in a situation in which the scent components 741 retained in the scent device 740 includes only a tea scent component and does not include a coffee scent component.

Likewise, a scent of apple may be classified into a smell of fruit as a superordinate concept, and the smell of fruit may be classified into a sweet scent as a more superordinate concept.

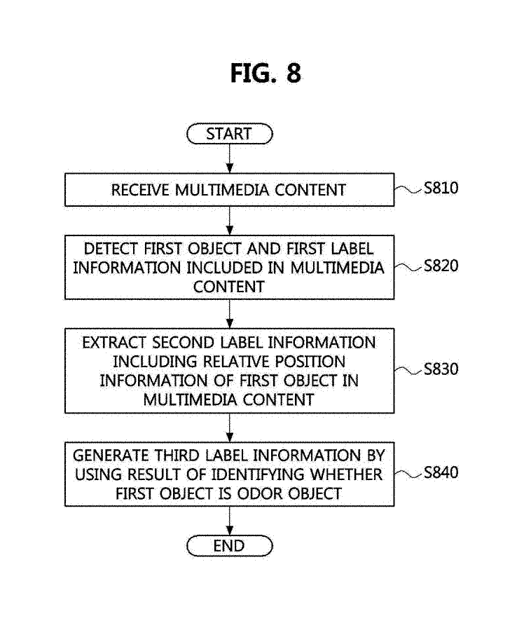

FIG. 8 is a flowchart illustrating an olfactory information recognition method according to one embodiment of the present invention.

Referring to FIG. 8, the olfactory information recognition method executed by a processor of the olfactory information recognizer according to one embodiment of the present invention is illustrated. The odor object detector 711 of the server 710 of FIG. 7 may form a part of the processor capable of executing the method of FIG. 8. The processor receives multimedia content (S810). The processor detects one or more first objects and first label information related to the first objects included in multimedia content (S820). Here, the operation of detecting the first label information and the first objects may be replaced by an operation of identifying label information added to the content and an object indicated by the label information. However, when content is unlabeled data, it is necessary to extract a first object through analysis on the data and to generate a first label. When the unlabeled data is an unlabeled image, an object may be identified through operations of segmentation, classification and localization, object detection, object classification, instance segmentation, and the like.

The processor extracts second label information including relative position information occupied by the one or more first objects in the multimedia content (S830). The operation may be performed by the above-described improved weakly supervised learning provided by the present invention. Here, the obtained second label information may include relative position information and relative size information of each of the first objects, a distance between each of the first objects and a center of the content, and a distance between the first objects when a plurality of such first objects are present.

The processor generates third label information by using a result of identifying whether the first object is an odor object (S840). Identifying whether the first object is the odor object may be performed by referring to a list of objects classifiable into odor objects defined in the database 720. Here, identifying whether the first object is the odor object may be performed considering a list of the scent components 741 of the scent device 740.

Operation S840 of identifying whether the first object is the odor object may be executed before operation S830, may be executed with operation S830 at the same time, and may be executed as a separate operation in parallel with operation S830. Operation S840 may be executed after operation S830 is executed. Since it is difficult to determining whether the first object is the odor object by simply using only image or sound data, operation S840 may be executed in additional consideration of context information.

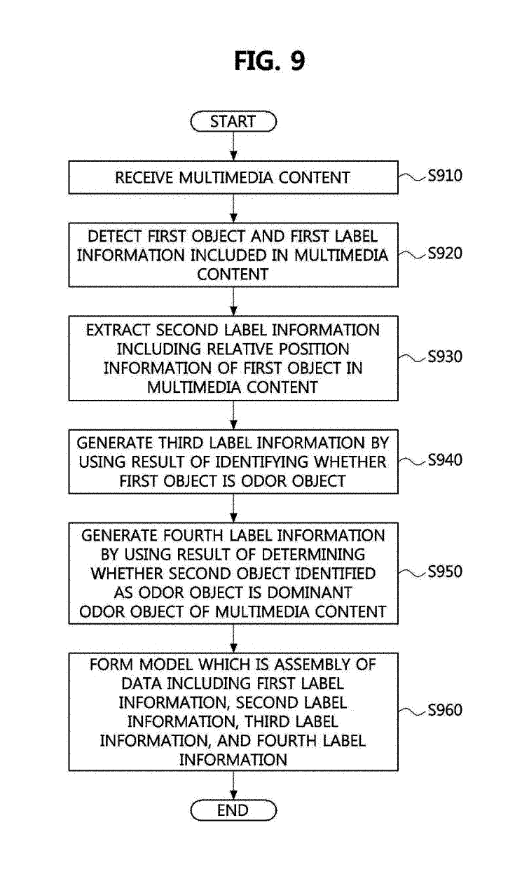

FIG. 9 is a flowchart illustrating an olfactory information recognition method according to one embodiment of the present invention.

Referring to FIG. 9, like the method of FIG. 8, the method may be executed by the processor of the olfactory information recognizer, and the odor object detector 711 of the server 710 of FIG. 7 may form a part of the processor capable of executing the method of FIG. 9.

Since operations S910, S920, S930, and S940 executed by the processor are executed similarly to operations S810, S820, S830, and S840 of FIG. 8, a repetitive description will be omitted.

A result of determining whether a second object identified as an odor object among first objects included in multimedia content is a dominant odor object of the content is generated as fourth label information (S950).

In the operation of identifying a dominant odor object, even though an object has a dominant size, an occupation rate, and a dominant occupation time in content, the object may not be a dominant odor object when a relation between the object and olfactory sense is weak. That is, to recognize the dominant odor object, it is necessary to additionally consider how strong an object relates to a particular olfactory sense/odor or how strong a human being feels the related odor.

In addition, a reference for determining whether an odor object is a dominant odor object may be replaced by a reference for determining whether other objects are dominant objects. That is, when content is an image, it may be considered how far an object is from a central part of the image, how great part a size of the object occupies in the whole image, and the like. When a human being is a visually dominant object in an image, since an odor object may be dominant as closer to the human being, a distance from other objects in the image may be additionally considered.

A model which is an assembly of data including the first label information, the second label information, the third label information, and the fourth label information is formed (S960).

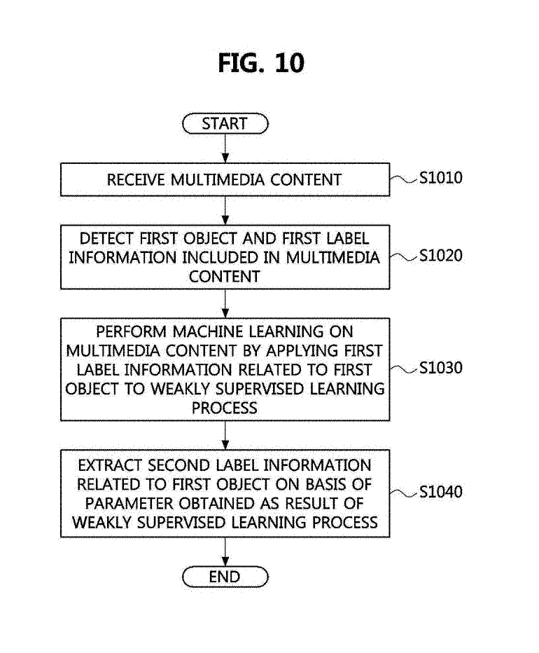

FIG. 10 is a flowchart illustrating a label information generation method according to one embodiment of the present invention.

The method of FIG. 10 may be executed by a processor included in a label information generator according to one embodiment of the present invention.

The processor receives multimedia content (S1010).

The processor detects one or more first objects and first label information corresponding to the first objects included in multimedia content (S1020).

The processor executes machine learning related to the multimedia content by applying the first label information related to the first objects to a weakly supervised learning process (S1030).

The processor extracts second label information related to the first objects on the basis of a parameter (a weight matrix) obtained as a result of the weakly supervised learning process (S1040). The second label information includes information on a relative position of the first object in the multimedia content.

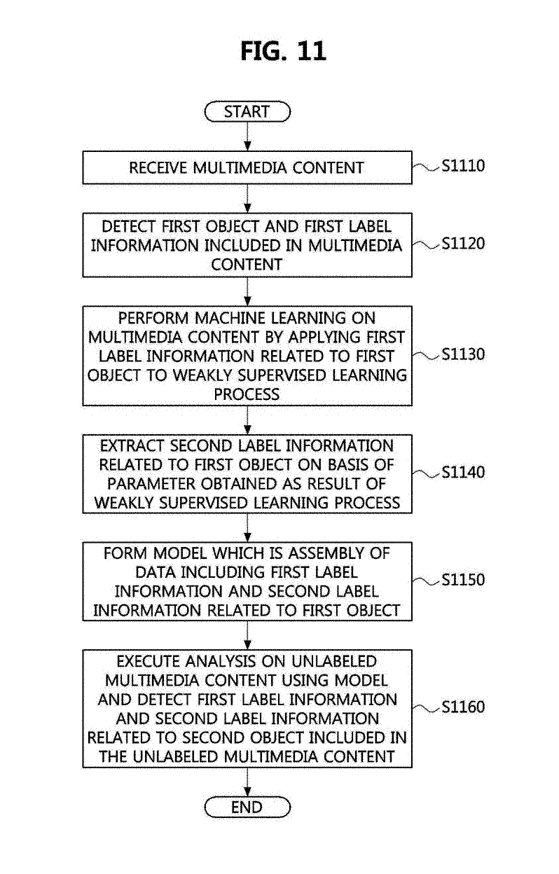

FIG. 11 is a flowchart illustrating a label information generation method according to one embodiment of the present invention.

Since operations S1110, S1120, S1130, and S1140 of FIG. 11 are similar to operations S1010, S1020, S1030, and S1040 of FIG. 10, a repetitive description will be omitted.

The processor forms a model which is an assembly of data including first label information and second label information related to a first object (S1150). The processor executes analysis on unlabeled multimedia content by using the model and detects first label information and second label information related to a second object included in the unlabeled multimedia content (S1160).

Characteristics of the scent component 741 retained in the scent device 740 and the like may be defined as characteristics related to olfactory sense of a media thing. In the case of a media thing, particularly for example, a scent emitting device, a plurality of scent components are generally used while being mounted on a scent cartridge. The scent component has individual characteristics and corresponds to a particular domain. Representation of the particular domain to which the scent component corresponds in a language intuitionally recognized by a human being is the label information of the scent component.

In another embodiment, it may be assumed that text-based label information related to a scent component is input by a user. Here, the label information related to the scent component may not be identical to generally used label information related to an odor image. The olfactory information generator may collect label information highly related to the label information input by the user and the label information related to the odor image related to the scent component through syntax analysis on a text. The olfactory information generator may store the label information input by the user related to the scent component and label information (generalized, standardized, or previously collected label information) derived through executing pattern recognition, database searching, and syntax analysis of the text together in the memory or the database.

The odor object may be embodied as a word associated with a particular category or a particular odor and with representativeness. Bacon, orange, coffee, water, tree, and the like are associated with particular smells and may suggest unique atmospheres thereof. For example, bacon may allude to an atmosphere of “during a meal,” orange may allude to something being sweet and fragrant, coffee may allude to an atmosphere of rest or talk, water may allude to something being fresh and healthy, and tree may allude to something being fresh and to an image of nature.

As described above, label information related to a particular odor object may be represented, and additional label information related to an abstract superordinate concept suggested by the label information may be added.

Otherwise, a plurality of superordinate concepts related to one odor object may be competitively listed. For example, since orange may be connected to a superordinate concept such as “fruit” and an abstract concept such as “sweet,” the orange may be connected to the above keywords.

Semantic similarity or semantic relation among the keywords of the odor object may be obtained by applying a natural language processing principle and may be further specified and diversified by artificial intelligence-based machine learning.

When the olfactory information recognizer is embodied as a separate device, the device may include a processor, a memory, a storage, and a communication module. The processor may perform functions of extracting an odor image, recognizing label information of the odor image (or transmitting a command to another media thing for recognition), and the like. Necessary information may be stored in a memory or a storage, and a communication module may be included for communication and sharing with other media things.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software. Examples of the computer readable medium may include magnetic media such as hardware disk, floppy disk, and magnetic tape, optical media such as CD-ROM and DVD, magneto-optical media such as floptical disk, ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the example embodiments of the present invention and their advantages have been described in detail, it should be understood that various changes, substitutions and alterations may be made herein without departing from the scope of the invention.

What is claimed is:

1. An olfactory information recognizer which recognizes olfactory information based on multimedia content, comprising a processor,
wherein the processor receives the multimedia content, detects one or more first objects and first label information with respect to the one or more first objects included in the multimedia content, extracts second label information including relative position information of the one or more first objects in the multimedia content, and generates third label information by using a result of identifying whether the detected one or more first objects are odor objects related to odors.

2. The olfactory information recognizer of claim 1, wherein the processor generates fourth label information by using a result of determining whether a second object, which is one of the one or more first objects and identified to be the odor object with respect to the multimedia content, is a dominant odor object of the multimedia content.

3. The olfactory information recognizer of claim 2, wherein the processor determines a ratio between an area occupied by the second object identified to be the odor object with respect to the multimedia content among the one or more first objects to the multimedia content, and whether the second object is the dominant odor object of the multimedia content on the basis of a relative position in the multimedia content.

4. The olfactory information recognizer of claim 1, wherein the processor performs machine learning with respect to the multimedia content by applying the first label information with respect to one or more first objects to a weakly supervised learning process and extracts the second label information with respect to the one or more first objects on the basis of a parameter obtained as a result of the machine learning by applying the first label information to the weakly supervised learning process.

5. The olfactory information recognizer of claim 4, wherein the processor extracts the second label information with respect to the one or more first objects on the basis of a distribution of feature weights of a convolution filter of a convolution neural network (CNN) while the machine learning by applying the first label information to the weakly supervised learning process is performed.

6. The olfactory information recognizer of claim 1, wherein the processor performs machine learning with respect to the multimedia content by applying the first label information with respect to the one or more first objects to a weakly supervised learning process and forms a model which is an assembly of data including the first label information, the second label information, and the third label information with respect to the multimedia content as a result of the machine learning.

7. A label information generator which generates label information based on multimedia content, comprising a processor,
wherein the processor receives the multimedia content, detects one or more first objects and first label information with respect to the one or more first objects included in the multimedia content, performs machine learning with respect to the multimedia content by applying the first label information with respect to the one or more first objects to a weakly supervised learning process, and extracts the second label information with respect to the one or more first objects on the basis of a parameter obtained as a result of the machine learning by applying the first label information to the weakly supervised learning process.

8. The label information generator of claim 7, wherein the processor extracts the second label information with respect to the one or more first objects on the basis of a distribution of feature weights of a convolution filter of a convolution neural network (CNN) while the machine learning by applying the first label information to the weakly supervised learning process is performed.

9. The label information generator of claim 7, wherein the processor forms a model which is an assembly of data including the first label information and the second label information with respect to the multimedia content as a result of the machine learning.

10. The label information generator of claim 9, wherein the processor analyzes unlabeled second multimedia content by using the model and detects first label information and second label information with respect to a second object included in the second multimedia content as a result of analyzing the second multimedia content.

11. An olfactory information recognition method of recognizing olfactory information based on multimedia content and executed by a device which forms Internet of Things (IoT) and includes a processor, the method comprising:
receiving, by the processor, the multimedia content;
detecting, by the processor, one or more first objects and first label information with respect to the one or more first objects included in the multimedia content;
extracting, by the processor, second label information including relative position information of the one or more first objects in the multimedia content; and
generating third label information by using a result of identifying whether the detected one or more first objects are odor objects related to odors.

12. The method of claim 11, further comprising generating, by the processor, fourth label information by using a result of determining whether a second object, which is one of the one or more first objects and identified to be the odor object with respect to the multimedia content, is a dominant odor object of the multimedia content.

13. The method of claim 12, wherein the generating of the fourth label information by using the result of determining whether the second object is the dominant odor object of the multimedia content comprises generating the fourth label information by using the result of determining whether the second object is the dominant odor object of the multimedia content on the basis of a ratio of an area occupied by the second object in the multimedia content and a relative position thereof in the multimedia content.

14. The method of claim 11, further comprising, by the processor, forming a model which is an assembly of data including the first label information, the second label information, and the third label information with respect to the multimedia content as a result of performing machine learning with respect to the multimedia content by applying the first label information with respect to the one or more first objects to a weakly supervised learning process.
